(19) United States
(12) Patent Application Publication
(10) Pub. No.: US 2024/0004614 A1
(43) Pub. Date: Jan. 4, 2024

(54) METHODS AND APPARATUS FOR ART WORK CREATION BY USING RANDOM NUMBERS AND RANDOM VARIABLES

(71) Applicant: Seong-In KIM, Seoul (KR)

(72) Inventor: Seong-In KIM, Seoul (KR)

(21) Appl. No.: 18/113,302

(22) Filed: Feb. 23, 2023

(30) Foreign Application Priority Data
Feb. 23, 2022 (KR) 10-2022-0023325
Feb. 22, 2023 (KR) 10-2023-0023338

(51) Int. Cl. G06F 7/58

(52) U.S. Cl. CPC G06F 7/588

(57) ABSTRACT

A method of creating an artwork includes generating a set of random numbers according to a seed, realizing values of random variables corresponding to first factors of basic objects forming an object according to random numbers selected from the set of random numbers, and creating first graphical information transformed from graphical information of the basic objects according to the values of the first factors.

### CROSS-REFERENCE TO RELATED APPLICATION

This application claims the benefit of Korean Patent Application No. 10-2022-0023325, filed on Feb. 23, 2022, in the Korean Intellectual Property Office, and Korean Patent Application No. 10-2023-0023338, filed on Feb. 22, 2023, in the Korean Intellectual Property Office, the disclosure of which is incorporated herein in their entirety by reference.

### BACKGROUND

### 1. Field

The disclosure relates to a method and apparatus for creating an artwork by using random numbers and random variables.

### 2. Description of the Related Art

Computer devices according to the related art represent characters by using a method of selecting a graphical information corresponding to text input by a user from among graphical information previously stored in a font file and displaying the selected graphical information on a screen.

Furthermore, the graphical information stored in the font file is not subject to change once it is created according to the design intended by a creator.

In such a computer environment, if one wants to create an artwork by modifying a method of representing one object such as a character in various ways, there is no choice but to manually create a new font, which requires substantially the same level of work as creating a font image manually.

As such, the creating an artwork using a computer according to the related art is substantially the same work as the manual artwork with only a change of a writing instrument, such as a pen, a brush, or the like, to an electronic pen. This is an issue equally applied to not only a character-related artwork, but also other forms of artwork.

### PRIOR ART DOCUMENTS

### Patent Literature

(Patent Literature 1) U.S. Ser. No. 10/311,366 B2
(Patent Literature 2) US 2009/0153551 A1
(Patent Literature 3) JP 2017-211579 A
(Patent Literature 4) JP 2004-117714 A

### SUMMARY

Provided is a method and apparatus for creating an artwork by using random numbers and probability distribution.

According to an aspect of the disclosure, a method of creating an artwork includes generating a set of random numbers according to a seed, realizing values of random variables corresponding to the first factors of a basic object forming an object according to random numbers selected from the set of random numbers, and creating the first graphical information transformed from graphical information of the basic objects according to the values of the first factors.

According to an aspect of the disclosure, an apparatus for creating an artwork includes a random number generator configured to generate one set of random numbers according to a seed, a first basic object generator configured to control realizing values of random variables corresponding to the first factors to determine deformation of basic objects forming an object according to random numbers selected from the set of random numbers, and a basic object rendering unit configured to create the first graphical information transformed from graphical information of the basic objects according to the determined values of the first factors.

### BRIEF DESCRIPTION OF THE DRAWINGS

These and/or other aspects will become apparent and more readily appreciated from the following description of the embodiments, taken in conjunction with the accompanying drawings in which:

FIG. 1 is a block diagram of an apparatus for creating an artwork, according to an embodiment;

FIGS. 2 and 3 are flowcharts of a method of creating an artwork, according to an embodiment;

FIG. 4 is a system diagram in the form of a decision tree showing a method of creating a Korean character object, according to an embodiment;

FIG. 5 is a diagram showing a method of creating a Korean character object, according to an embodiment;

FIG. 6 a diagram of vowels used in a method of creating a Korean character object, according to an embodiment, which are classified by type;

FIG. 7 is a diagram of initial consonants and final consonants used in a method of creating a Korean character object, according to an embodiment, which are classified by type; and

FIGS. 8 to 16 illustrate examples of an artwork created by applying the disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

In the following description, an embodiment of the disclosure is described with reference to the accompanying drawings.

First, the meaning of terms used in the following disclosure is defined as follows.

An “object,” as a unit included in an artwork, may be one character, one image (e.g., a water drop image), or one figure (e.g., a rectangle).

A “basic object,” as a detailed unit forming an object, corresponds to, for example, a stroke of a character, a shadow of a water drop, an edge of a rectangle, or the like.

“Factors” denote the characteristics of a basic object and includes the first factors and the second factors.

“The first factors” include the shape, size, position, and the like, and the size may be represented by, for example, the horizontal length and the vertical length.

“The second factors” include the thickness, color, shading, inclination, and the like.

“Variation” corresponds to the variety of one factor. For example, a discrete variation of a length factor may be expressed by long, middle, and short, and a continuous variation may be expressed by one real number value (e.g., 5.326 cm).

“Probability distribution” can be discrete or continuous. Discrete probability distribution includes multinomial distribution and the like, and continuous probability distribution includes normal distribution, truncated normal distribution, and the like.

“Order in chaos” is a characteristic that is appreciated in an artwork of certain kinds (e.g., an artwork that is composed of similar but different patterns).

A degree of “chaos” or “order” may be quantified by probability theory.

“Random numbers” represents a series of numbers in which ten numbers of {0, 1, 2, . . . , 9} are arranged. While there is chaos because no one can predict what number will come next, there is order because the rate at which each number appears tends to be closer to 1/10 as the number of random numbers increases.

“Parameter” represents the characteristics of random variables. In a discrete probability distribution, the probability of each outcome corresponds thereto, and in a continuous probability distribution, average, standard deviation, and the like corresponds thereto.

“Seed” is an input number for a random number generator of a computer to generate a set of random numbers. When a seed varies, another set of random numbers is generated.

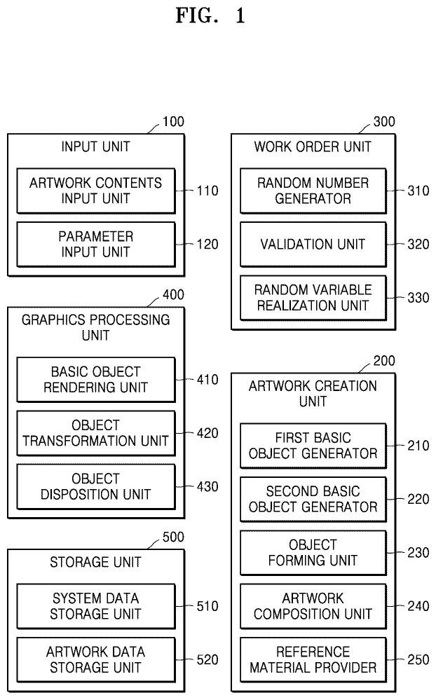

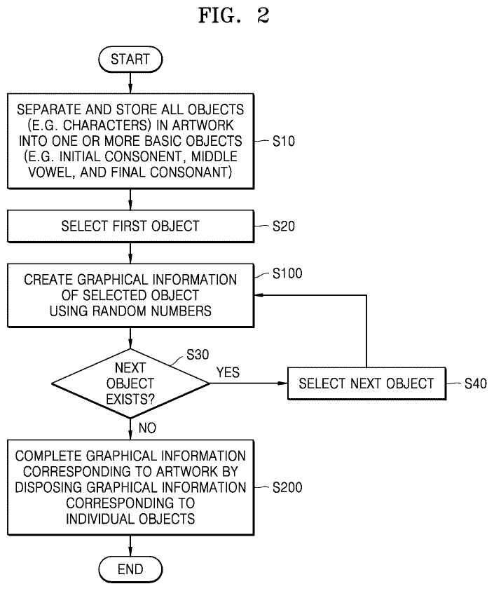

FIG. 1 is a block diagram of a configuration of an apparatus for creating an artwork, according to an embodiment.

In the disclosure, in order to realize “order in chaos,” which is one of the characteristics of an artwork, the spatial and morphological relationships between basic objects forming the work, or between objects, are systematized. In this process, a system diagram in the form of a decision tree may be established.

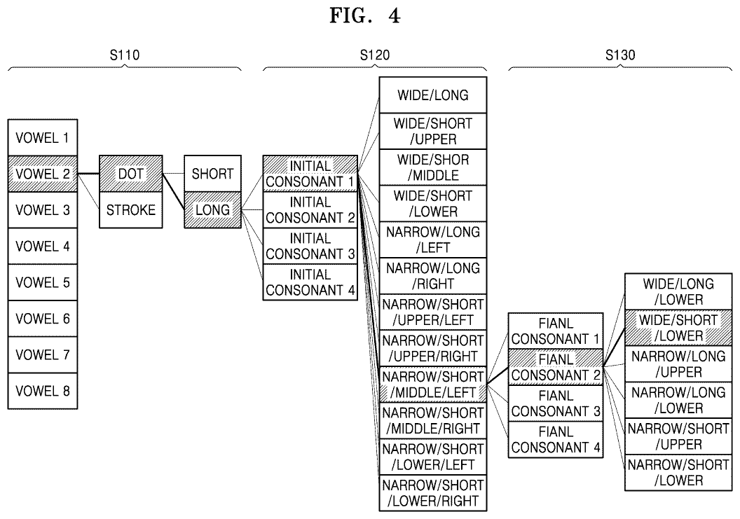

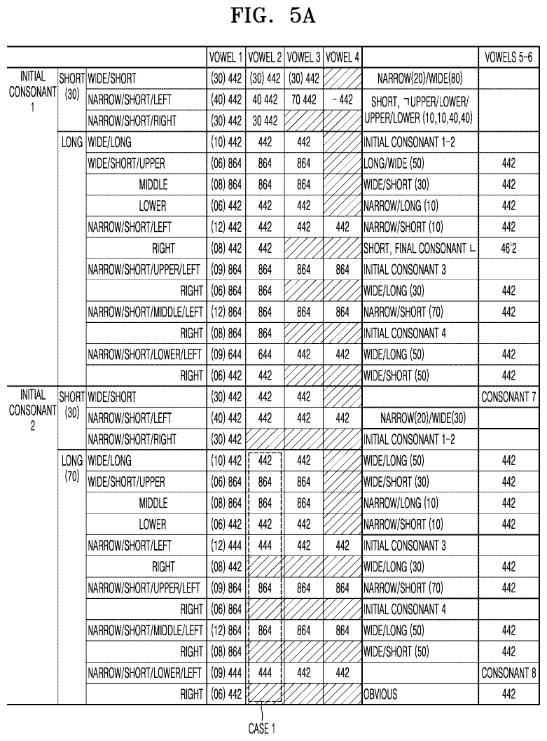

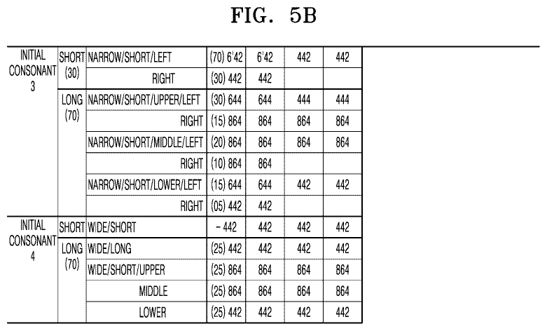

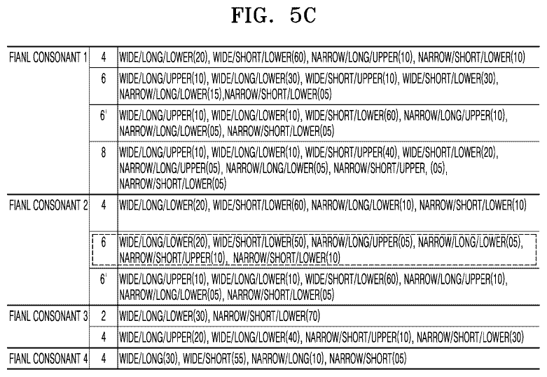

In the fields of calligraphy, font development, character design, and the like, where Korean characters are involved, a system of the form shown in FIGS. 4 and 5 may be considered as an example.

The system is designed to provide a maximum diversity to the objects that constitute the artwork, the basic objects (e.g., an initial consonant, a middle vowel, and a final consonant) that constitute each object, the factors that form the characteristics of each basic object (e.g., stroke size, shape, shading), and the variation of each factor (e.g., large size, medium size, small size).

According to this scheme, the values of discrete type or continuous type random variables may be realized independently by generating random numbers with the characteristic of “order in chaos” without any intervention of the operator's will.

An artwork composed of basic objects created to have a variation corresponding to the realized values, and objects composed of the basic objects and created to have variations, may embody “order in chaos,” which is one of the characteristics of artistry, depending on the nature of the random numbers underlying the composition thereof.

Furthermore, whenever using a different seed, a different piece of artwork realizing “order in chaos” with different objects may be obtained.

Therefore, an apparatus for creating an artwork according to the present embodiment may quickly create a myriad of artworks corresponding to different seeds through an automated process.

Referring back to FIG. 1, the configuration and operation of an apparatus for creating an artwork according to the embodiment are disclosed.

The apparatus for creating an artwork according to the present embodiment includes an input unit 100, an artwork creation unit 200, a work order unit 300, a graphics processing unit 400, and a storage unit 500.

The input unit 100 receives an artwork content, sets a work guideline, and stores the artwork content and guideline in the storage unit 500.

The artwork creation unit 200 controls the graphics processing unit 400 according to the work guideline stored in the storage unit 500 and the order by the work order unit 300, completes an artwork, and stores the completed artwork in the storage unit 500.

The input unit 100 includes an artwork contents input unit 110 and a parameter input unit 120.

The artwork creation unit 200 includes the first basic object generator 210, the second basic object generator 220, an object forming unit 230, an artwork composition unit 240, and a reference material provider 250.

The work order unit 300 includes a random number generator 310, a validation unit 320, and a random variable realization unit 330.

The graphics processing unit 400 includes a basic object rendering unit 410, an object transformation unit 420, and an object disposition unit 430.

The storage unit 500 includes a system data storage unit 510 and an artwork data storage unit 520.

In the following description, the configuration and operation of an apparatus for creating an artwork is described in detail with an example of an artwork comprising characters, in particular, Korean characters, but the type of artwork is not limited thereto.

First, the function of the input unit 100 is described below.

The artwork contents input unit 110 receives characters to be processed from existing fonts, handwriting, calligraphy images, or the like, by using the function of the object transformation unit 420, and stores the received characters in the artwork data storage unit 520.

For Korean characters as an example, the images of existing fonts, handwriting, or calligraphy may be created to have the shapes and sizes corresponding to basic frames of consonants or vowels, and stored in advance. These serve as a basis for determining factors by using random numbers.

The parameter input unit 120 determines, for each work, seeds for generating one or more random number sets and parameters of random variables, and stores the seeds and the random number sets in the system data storage unit 510.

Next, the function of the artwork creation unit 200 is described below.

The first basic object generator 210 receives characters to be processed stored in the artwork data storage unit 520, divides the characters into basic objects, each including an initial consonant, a middle vowel, and/or a final consonant, by using the object transformation unit 420, and stores the basic objects in the artwork data storage unit 520.

Furthermore, the first basic object generator 210 reads the random numbers stored in the system data storage unit 510, realizes the values of random variables corresponding to the random numbers by using the random variables realization unit 330, determines a variation of a shape, a size, a position, and the like, which are the first factors of the basic objects by using the basic object rendering unit 410, and provides the result thereof to the second basic object generator 220.

Here, ‘realizing the values of random variables’ means that, for example, when the selected random number is 0 to 3, the size (one of the first factors) is determined to be “large,” when the selected random number is 4 to 6, the size (one of the first factors) is determined to be “middle,” and when the selected random number is others, the size (one of the first factors) is determined to be “small.” “Large,” “middle,” and “small” correspond to values predetermined according to an embodiment.

In this state, the determined variation corresponds to an inverse function value of a cumulative distribution function of random variables corresponding to random numbers. In other words, in an inverse function x=F⁻¹(y) of a cumulative distribution function y=F(x) with respect to a random variable y, the realized value of a created random number u is F⁻¹(u).

The second basic object generator 220, with respect to the output of the first basic object generator 210, reads the random numbers stored in the system data storage unit 510, realizes the values of random variables corresponding to the random numbers by using the random variables realization unit 330, determines a variation such as a thickness, a color, shading, inclination, and the like, which are the second factors of the basic objects, by using the basic object rendering unit 410, transfers a result thereof to the next step of operation, and stores the result in the artwork data storage unit 520.

In this state, the determined variation corresponds to the inverse function value of a cumulative distribution function of random variables corresponding to random numbers.

The object forming unit 230 enlarges or shrinks the objects according to the random numbers of the random number generator 310 by using the object transformation unit 420, transfers the result thereof to the next step of operation, and stores the result in the artwork data storage unit 520.

The artwork composition unit 240 provides the objects to the object disposition unit 430 and controls the objects to be formed as an artwork. In this state, information about the arrangement of objects may be received from a user, or a predetermined arrangement method may be used.

The reference material provider 250 may store and provide all results of the existing artwork-creating operation, and create and provide alternative artworks by applying a random numbers set created by using other seeds.

The artwork creation unit 200 according to the disclosure may create a work with “order in chaos” by applying random numbers and random variables.

The artworks created as above may be appreciated as works of art by themselves and may be used as reference materials for creating a new artwork.

Next, the function of the work order unit 300 is described below.

The random number generator 310 receives a seed from the system data storage unit 510, creates a series of random numbers sets therefrom, and stores the created random numbers sets in the system data storage unit 510.

The validation unit 320 verifies appropriateness of the random numbers sets created by the random number generator 310. In this state, a method such as a χ2 test (Chi-square goodness of fit test) may be used. When it is verified to be inappropriate, the random number generator 310 is ordered to generate a new set of random numbers by using another seed.

The system data storage unit 510 stores a series of random numbers sets verified to be appropriate.

As the functions of the random variable realization unit 330, and the basic object rendering unit 410, the object transformation unit 420, and the object disposition unit 430, which are included in the graphics processing unit 400, are already described above, redundant descriptions thereof are omitted.

Next, the storage unit 500 is described below.

The system data storage unit 510 stores pieces of data about the random numbers set and parameters related to the system.

The artwork data storage unit 520 stores the textual information of the artwork content, the original frames of basic objects (initial consonants, middle vowels, and/or final consonants), an object reflecting a variation of a shape, a size, and a position of basic objects, and a variation of a thickness, a color, shading, and inclination of basic objects, and graphical information corresponding to a final artwork reflecting the enlargement or shrinkage of objects.

As the functions of the system data storage unit 510 and the artwork data storage unit 520 are as described above, detailed descriptions thereof are omitted.

FIG. 2 is a flowchart of a method of creating an artwork, according to an embodiment.

First, all objects forming an artwork are received and basic objects corresponding to each object are separated and stored (S10). For example, when the work is configured with a plurality of Korean characters, each object corresponds to one character, and the basic object corresponds to an initial consonant, a middle vowel, or a final consonant of each character.

Next, the first object is selected (S20).

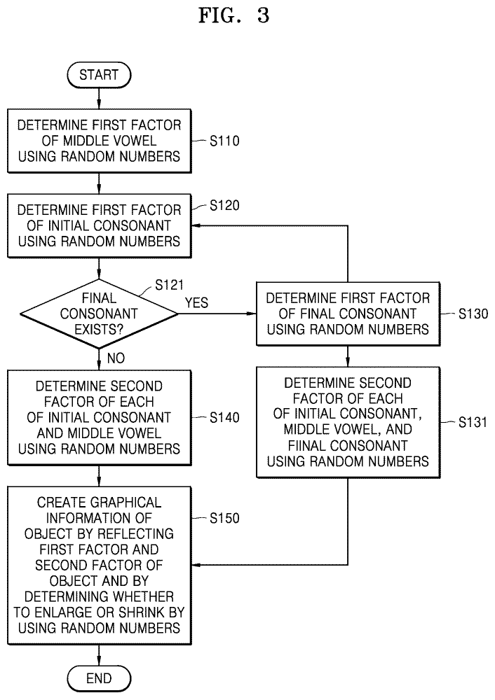

Next, graphical information corresponding to the first object is created by using random numbers (S100). This will be described below in detail with reference to FIG. 3.

Next, whether there is a next object of which the graphical information is not created is determined (S30).

If the next object exists, the next object is selected (S40), and the operation S100 described above is repeated.

Otherwise, graphical information corresponding to the artwork is completed by arranging graphical information corresponding to the plurality of objects (S200). In this state, information about the arrangement of objects may be received from a user, or a predetermined arrangement method may be used.

Although, in FIG. 2, it is assumed that all characters included in one artwork are previously stored, the disclosure is not limited thereto.

For example, for an artwork comprising characters, a sentence may be input by using a keyboard and the like, a process of transforming a work by reflecting graphical information corresponding to the character input in real time simultaneously with each character input may be shown, and the completion of a work when a character or a special key indicating the last of a sentence is input may be shown.

FIG. 3 is a flowchart of a method of creating graphical information of an object (S100), according to an embodiment.

The flowchart of FIG. 3 is based on an assumption that basic objects are an initial consonant, a middle vowel, and a final consonant of Korean character.

In the present embodiment, a variation of the first factors of the length and shape of a middle vowel of a basic object is primarily determined. In this state, values of random variables corresponding to the first factors are realized by using random numbers, and the variation is determined as one corresponding to the realized values (S110).

Basically, a variation of the first factors of each of an initial consonant, a middle vowel, and a final consonant may be independently determined. However, in the case of Korean characters, due to a limitation in the positional relationship among an initial consonant, a middle vowel, and a final consonant, when a first factor such as a size is independently determined, the shape of a character may become incomprehensible or may form an incomplete character shape.

Accordingly, in the present embodiment, limiting conditions among an initial consonant, a middle vowel, and a final consonant are assigned, and for systemization, a first factor of a middle vowel is first determined, and then, first factors of an initial consonant and a final consonant are determined.

As described above, the first factor includes a shape, a size, a position, and the like, and a method of determining a first factor of a vowel is described with reference to FIG. 4 as follows.

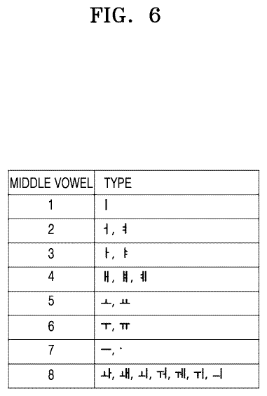

In the present embodiment, vowels are classified into eight types from “vowel 1” to “vowel 8,” and vowels corresponding to the respective types are illustrated in FIG. 6.

Referring to FIG. 4, when a current basic object corresponds to “vowel 2,” that is, a vowel corresponds to “ [symbol] ” or “ [symbol] ,” “dot” or “stroke” is determined, and then “short” or “long” is selected.

In this state, the “dot” is a way of expressing “ [symbol] ” by using a dot, like “ [symbol] ” that is the old form of a vowel, and the “stroke” is a way of expressing “ [symbol] ” by using a stroke, like “ [symbol] ”.

This corresponds to the shape that is one of the first factors.

In the present embodiment, this is set to be random variables and the values of random variables are realized by using random numbers. The meaning of realizing the values of random variables by using random numbers is as described above. In this state, a probability of selecting “dot” and a probability of selecting “stroke” may be variously adjusted according to an embodiment.

Next, the “short” or the “long” corresponds to decreasing or increasing the length of a vertical stroke of “ [symbol] ,” which corresponds to the size (vertical length) that is one of the first factors.

In this state, a probability of selecting “short” and a probability of selecting “long” may be variously adjusted according to an embodiment.

FIG. 4 illustrates that the “dot” and the “long” are selected as the first factors of “vowel 2”.

Although in the above, the shape and the vertical length are presented as examples of the first factors, the type of first factors to be determined may be changed according to an embodiment.

Referring back to FIG. 3, next, the first factors of an initial consonant are determined by using random numbers (S120).

Referring to FIGS. 4 and 5, a method of determining first factors of an initial consonant is described as follows.

As described above, although it is rule to determine the first factors of the basic objects independently of each other, there may be some limiting conditions therebetween.

The diagrams of FIGS. 4 and 5 may be understood as a systemized method of determining first factors to have a maximum diversity while satisfying the limiting conditions.

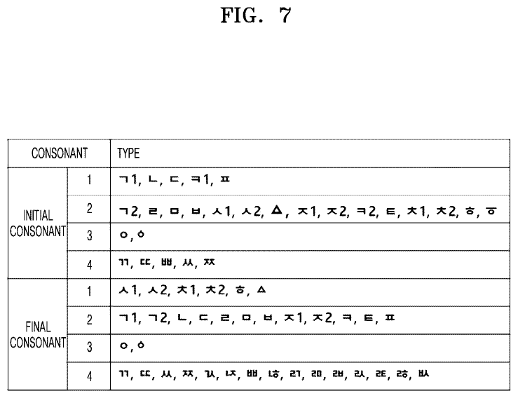

In the present embodiment, the initial consonant belongs to any one of “initial consonant 1” to “initial consonant 4” as illustrated in FIG. 7.

FIG. 4 illustrates that, in the present embodiment, an initial consonant corresponds to “initial consonant 1,” and as illustrated in FIG. 7, the “initial consonant 1” corresponds to any one of “ [symbol] 1, [symbol] 1, [symbol] ”.

In this state, “ [symbol] 1” indicates any one of the shapes of “ [symbol] ”. For example, the shape of “ [symbol] ” may be classified into an angled shape and a round shape. In this state, “ [symbol] 1” and “ [symbol] 2” may be previously assigned to an angled shape and a round shape. Furthermore, “ [symbol] 1” or “ [symbol] 2” may be determined in the first factor determining process by a method of realizing the values of random variables by using random numbers.

In FIG. 4, “wide/long, wide/short/upper, wide/short/middle, wide/short/lower, narrow/long/left, narrow/long/right, narrow/short/upper/left, narrow/short/upper/right, narrow/short/middle/left, narrow/short/middle/right, narrow/short/lower/left, narrow/short/lower/right,” which correspond to the “initial consonant 1,” are a list of variations of first factors that the “initial consonant 1” may have, which are obtained by synthesizing individual first factors of the size and the position.

For example, “wide” or “narrow” corresponds to the horizontal width, “long” or “short” corresponds to the vertical length, “upper,” “middle,” or “lower” indicates the position in a vertical direction, and “left” or “right” indicates the position in a horizontal direction.

In this state, specific values of the size corresponding to “wide,” “narrow,” “long,” or “short” and the position corresponding to “upper,” “middle,” “lower,” or “left,” “right” may be previously determined according to an embodiment.

Although each of the individual first factors may be independently determined, a synthesized first factor may be made by combining one or more individual first factors, and random variables corresponding thereto are set and values thereof may be determined by using random numbers.

FIG. 4 illustrates that “narrow/short/middle/left” is determined as the first factors of an initial consonant.

Referring back to FIG. 3, next, whether a final consonant exists is determined (S121).

If a final consonant exists, the first factors of the final consonant are determined by using random numbers (S130).

Referring to FIG. 4, the final consonant corresponds to “final consonant 2,” and the first factor of “final consonant 2” is any one of six variations of “wide/long/lower,” “wide/short/lower,” “narrow/long/upper,” “narrow/long/lower,” “narrow/short/upper,” and “narrow/short/lower”.

In the present embodiment, for the final consonant like the initial consonant, a synthesized first factor is made by synthesizing individual first factors, and FIG. 4 illustrates that “wide/short/lower” is determined by using random numbers.

Referring back to FIG. 3, when all first factors are determined, the second factors are determined for each of the initial consonant and the middle vowel by using random numbers (S140). If a final consonant exists, the second factors are determined with respect to the final consonant (S131).

Next, graphical information of an object is created by reflecting the first factor and the second factor determined with respect to the basic object (S150). In this state, whether to enlarge or shrink an object is set by random variables, and the values thereof may be determined by using random numbers.

FIG. 5 is a diagram showing a method of creating a Korean character object, according to an embodiment.

As described above, the diagrams of FIG. 5 show that, when the object is Korean character and the first factors between basic objects are created independently, a system is established to provide maximum diversity to the first factors of an initial consonant, a middle vowel, and a final consonant, while preventing that the shape of a character is not established or disturbed.

For example, (A) and (B) of FIG. 5 show that, when a vowel of a target character belongs to any one of “vowel 1” to “vowel 6,” a variation of first factors that an initial consonant may have, and when the initial consonant belongs to any one of “initial consonant 1” to “initial consonant 4,” a variation of first factors that a final consonant may have.

For example, a method of using the diagrams of FIG. 5 when an object is “ [symbol] ” is described below.

First, a vowel is “ [symbol] ” which corresponds to “vowel 2” as shown in the diagram of FIG. 6.

FIG. 5 shows that, for “vowel 2,” “short” may be selected at a probability of 30% and “long” may be selected at a probability of 70%. For example, when random numbers is any one of 0 to 2, “short” is selected, and when random numbers is any one of 3 to 9, “long” is selected.

In the diagrams of FIG. 5, a portion indicated as “case1” corresponds to a variation of first factors that “initial consonant 2” may have, when “long” is selected for “vowel 2”.

It is assumed that, when the initial consonant is “ [symbol] ,” the shape that is a first factor is determined to be “ [symbol] 2”. In this state, determining to be “ [symbol] 1” or “ [symbol] 2” is also determined by random numbers and random variables, and in the present embodiment, it is assumed to be determined to be the shape of “ [symbol] 2”.

The initial consonant “ [symbol] ” corresponds to “initial consonant 2”.

In this case, the diagrams of FIG. 5 show that, as a variation of synthesis components consisting of three components of a horizontal length, a vertical length, and a position of the initial consonant, any one of “wide/long,” “wide/short/upper,” “wide/short/middle,” “wide/short/lower,” “narrow/long/left,” “narrow/long/right,” “narrow/short/upper/left,” “narrow/short/upper/right,” “narrow/short/middle/left,” “narrow/short/middle/right,” “narrow/short/lower/left,” and “narrow/short/lower/right” are determined to be probabilities of 10%, 6%, 8%, 6%, 12%, 8%, 9%, 6%, 12%, 8%, 9%, and 6%, respectively.

In “case1,” when “narrow/short/upper/left” is selected, the final consonant corresponds to 864, which means that, in (C) of FIG. 5, when the final consonant belongs to one of “final consonant 1,” “final consonant 2,” and “final consonant 3,” a variation of first factors corresponding to the numbers 8, 6, and 4, respectively, may be determined. When the final consonant belongs to “final consonant 4,” there is only one component variation configuration corresponding to 4.

For example, in a character “ [symbol] ,” the final consonant is “ [symbol] ,” which belongs to “final consonant 2” with reference to FIG. 7.

Referring to (C) of FIG. 5, any one of “wide/long/lower,” “wide/short/lower,” “narrow/long/upper,” “narrow/short/upper,” and “narrow/short/lower,” which are variations of the first factors corresponding to the number 6 of “final consonant 2,” may be determined to be probabilities of 20%, 50%, 5%, 5%, 10%, and 10%, respectively.

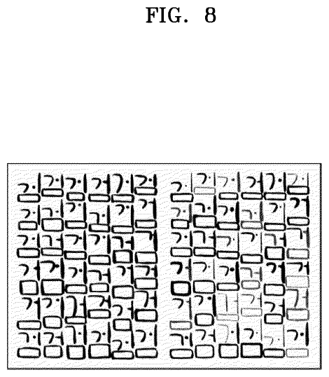

FIG. 8 illustrates various shapes of an object graphics image created according to different random numbers by applying the method of FIG. 3 to the character “ [symbol] ”. 36 characters in the left of FIG. 8 are based on a result of a variation of first factors, and 36 characters in the right are based on a result of adding only “shading” as a second factor in addition thereto.

In FIG. 8, as the second factors of a basic object, a color or inclination is not reflected and enlargement or shrinkage of an object is not considered. However, reflecting these second factors could be easily derived by a person skilled in the art through a design change.

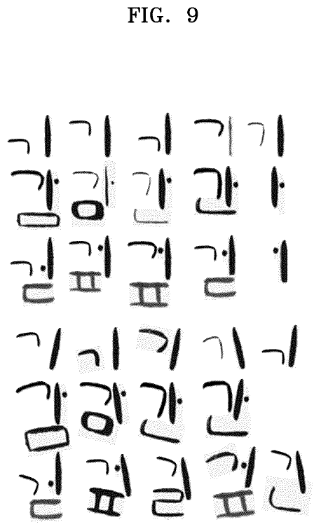

FIG. 9 illustrates some characters created by reflecting inclination as a second factor of a basic object.

Although FIG. 9 illustrates objects consisting of only vowels such as “ [symbol] ” and “ [symbol] ” this corresponds to the omission of the operations (S120, S121, S130, and S131) and the disregarding of the initial consonant in the operation (S140), in the method of FIG. 3.

As such, the object with only one basic object is one that could be easily derived by a person skilled in the art through a design change to the disclosure.

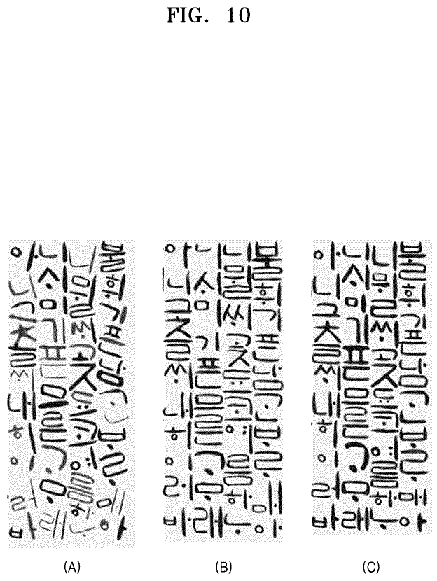

(A), (B), and (C) of FIG. 10 are works created by applying a part of “Yongbieocheonga” (the first work written in Korean characters) to the disclosure.

(B) and (C) are examples in which a variation of first factors is determined by different random numbers sets, and (A) is an addition of a variation of a thickness, shading, and inclination, as second factors, to the result of (B).

As such, according to the disclosure, by generating different sets of random numbers by changing the seed or varying the primary or second factors, a new type of work creation may be easily created for the same sentence.

Although the disclosure describes, as an example, Korean characters having a plurality of basic objects, the method described above may be applied to the numbers or Roman characters that seem to have one basic object. For example, in FIG. 3, a simple case of having only one middle vowel is assumed, and then, the first factor and the second factor of the middle vowel may be determined. Furthermore, assuming that a number or one of the Roman characters is divided into some parts and there are several basic objects, the first factor and the second factor may be determined by applying the method described above for each basic object.

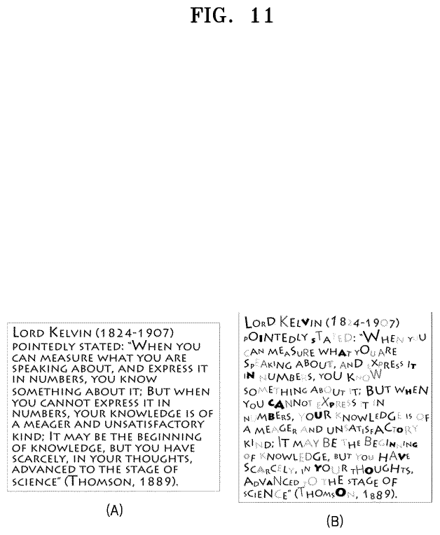

FIG. 11 illustrates an example of a work created by applying the method described above to a quote including numbers and Roman characters.

When sentences are written by using existing fonts, as illustrated in (A) of FIG. 11, only a single piece of stylized graphical information may be created.

However, when the method described above is applied to the same sentences, various pieces of graphic information modified by random numbers may be created according to the time of creation. (B) of FIG. 11 illustrates one of the various pieces of graphic information.

The method described above may be applied to other languages such as Chinese characters, Japanese characters, and the like, having more basic objects than Korean characters. For Chinese characters, basic objects are divided considering radicals and the like and limiting conditions as shown in FIG. 5 are set considering the positional relationship between basic objects, and thus, automated work creation is possible by the method described above.

However, in the case of Chinese characters, more conditions may be included in setting the limiting conditions as shown in the diagram of FIG. 5 due to different writing properties from Korean characters.

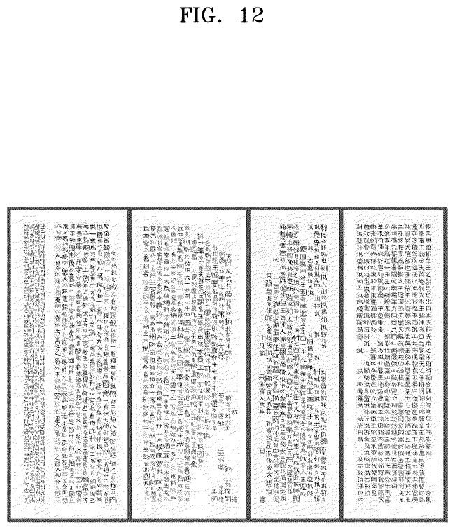

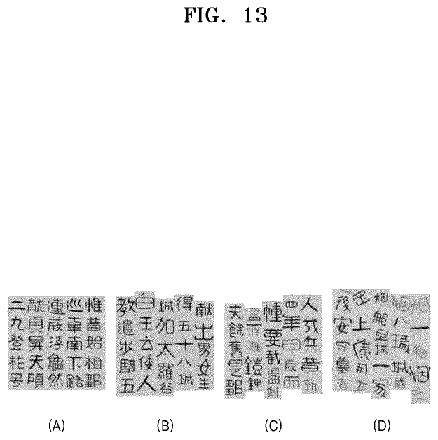

FIG. 12 illustrates an example of a work creation in various shapes that are automatically created by applying the method described above step by step to components on the four surfaces of the epitaph of King Gwanggaeto the Great, and (A), (B), (C), and (D) of FIG. 13 illustrate excerpts from the respective surfaces of FIG. 12.

The method described above may be applied to a case in which a basic object is an image. For example, when a water drop image is a basic object, the number, size, position, and shape thereof are first factors, the color, inclination, shading, and the like are second factors, various pieces of water drop graphical information may be created.

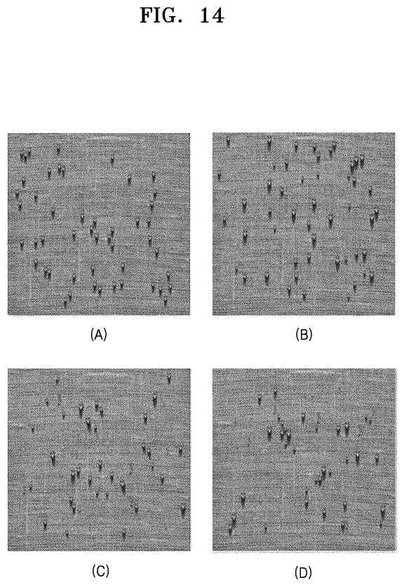

(A), (B), (C), and (D) of FIG. 14 illustrate various works created by applying the method described above step by step to the components of a work including a plurality of water drop images.

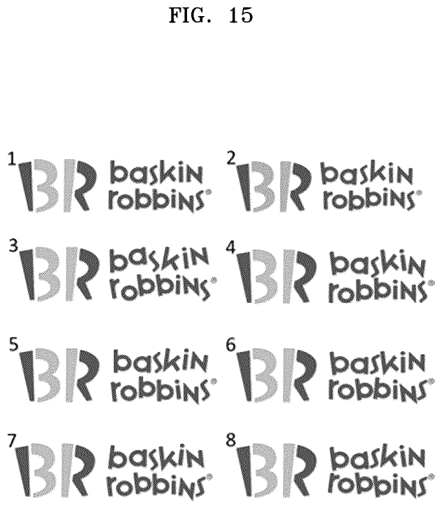

FIG. 15 illustrates various works created by applying the method described above to a trademark logo.

The original logo is denoted by the number 2, and the other logos correspond to logos created variously by applying the method described above to the original logo.

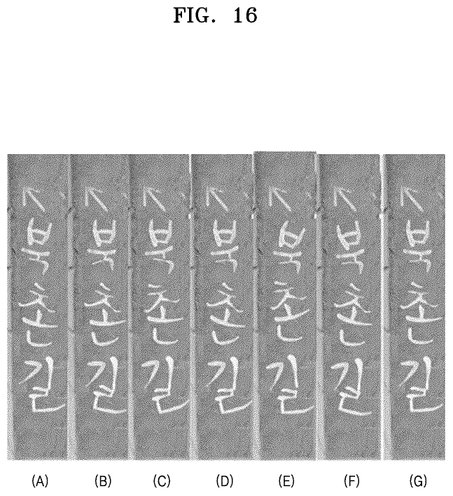

FIG. 16 illustrates road sign designs created variously by applying the method described above to a road sign.

(A) of FIG. 16 is a road sign that is currently used, and the others correspond to road sign designs created variously by applying the method described above to the road sign.

Through the method and apparatus for creating an artwork according to the disclosure, various artworks such as a character work and the like may be automatically created.

Through the method and apparatus for creating an artwork according to the disclosure, various character artworks may be created in which the characteristics such as the shape, position, size, and the like of each character are randomly determined by a probability.

Through the method and apparatus for creating an artwork according to the disclosure, various artworks in which “order in chaos” that is the characteristic of random numbers is realized may be created.

Compared with existing methods that create only one variation of an object or basic object that best matches the surroundings or fits personal preferences, the method described above establishes a system that can provide the maximum variation of changes, and basic objects and objects of various shapes are created by the values of random variables realized by randomly generated random numbers without any intervention of the artist's will, within the given room for change, and the configuration of the entire work comprising basic objects and objects of various shapes has artistry (order in disorder).

The phrase “order in chaos,” often used as a compositional feature of objects in artworks, is a vague concept, but probability theory gives the phrase an objective, numerical representation.

The implementation of artistry (order in chaos) is guaranteed through a probability theory in a work created by employing the method described above. As the number of objects and components of a work increases, a probability of implementing “order in chaos” that is one of artistic features increases, and the appropriateness may be quantified and verified by statistical methods.

Meanwhile, depending on the set of random numbers that have the same work content but is generated differently depending on the seed, objects with different component variations are created, and thus, various results are obtained accordingly. Each resultant can be a work in itself, or a useful reference for the conception of a work.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the disclosure as defined by the following claims.

What is claimed is:

1. A method of creating an artwork, the method comprising:
generating a set of random numbers according to a seed;
realizing values of random variables corresponding to first factors of basic objects forming an object according to random numbers selected from the set of random numbers; and
creating first graphical information transformed from graphical information of the basic objects according to the values of the first factors.

2. The method of claim 1, further comprising: realizing values of random variables corresponding to second factors to deform the basic objects according to random numbers selected from the set of random numbers; and
creating second graphical information that is deformed according to realized values of random variables of the second factors from the first graphical information.

3. The method of claim 2, further comprising: controlling to enlarge and shrink the object according to random numbers selected from the set of random numbers; and
creating object graphical information from the secondary graphical information.

4. The method of claim 2, wherein the first factors comprise at least one of a shape, a size, or a position of the basic objects, and the second factors comprise at least one of a thickness, a color, shading, or inclination.

5. The method of claim 3, further comprising creating artwork graphical information by disposing the object graphical information.

6. The method of claim 5, wherein the creating of the artwork graphical information comprises realizing values of random variables for a positon of object graphical information by using the random numbers.

7. The method of claim 6, wherein the object comprises one basic object, and the basic object includes a unit image or a figure.

8. The method of claim 1, further comprising: verifying appropriateness of the one set of random numbers; and when the one set of random numbers is verified to be inappropriate in a validation unit, changing the seed to change the one set of random numbers.

9. The method of claim 1, wherein the object includes Korean character, the basic object includes an initial consonant, a middle vowel, or a final consonant of Korean character, and the creating of the first graphical information comprises, after determining the first factors of the middle vowel, determining the first factors of the initial consonant or the first factors of the final consonant.

10. The method of claim 9, wherein the creating of the first graphical information comprises, by using a system diagram in a form of a decision tree, after determining the first factors of the middle vowel, determining the first factors of the initial consonant or the first factors of the final consonant, the system diagram in the form of the decision tree including information about a combination method considering spatial and morphological relationships of the initial consonant, the middle vowel, and the final consonant, the determining of the first factors of the middle vowel and the determining of the first factors of an initial consonant or the first factors of a final consonant being correspond to branching based on a probability in the system diagram in the form of the decision tree.

11. An apparatus for creating an artwork, the apparatus comprising:
a random numbers generator configured to generate one set of random numbers according to a seed;
a first base object generator configured to control realizing values of random variables corresponding to first factors to determine deformation of basic objects forming an object according to random numbers selected from the set of random numbers; and
a basic object rendering unit configured to create first graphical information determined according to the realized values of random variables of the first factors from graphical information of the basic objects.

12. The apparatus of claim 11, further comprising: a second basic object generator configured to control realizing values of random variables corresponding to second factors to determine a variation of the basic objects according to random numbers selected from the set of random numbers,
wherein the basic object rendering unit is further configured to create second graphical information that is deformed according to realized values of random variables of the second factors from the first graphical information.

13. The apparatus of claim 12, further comprising: an object forming unit configured to control to enlarge and shrink the object according to random numbers selected from the set of random numbers; and an object transformation unit configured to create object graphical information from the second graphical information under control of the object forming unit.

14. The apparatus of claim 12, wherein the first factors comprise at least one of a shape, a size, or a position of the basic objects, and the second factors comprise at least one of a thickness, a color, shading, or inclination.

15. The apparatus of claim 13, further comprising an object disposition unit configured to dispose the object graphical information so that artwork graphical information corresponding to an object disposition result is created.

16. The apparatus of claim 15, wherein the object disposition unit is further configured to realize values of random variables for a position of object graphical information by using the random numbers.

17. The apparatus of claim 16, wherein the object comprises one basic object, and the basic object includes a unit image or a figure.

18. The apparatus of claim 11, further comprising a validation unit configured to verify appropriateness of the one set of random numbers, wherein, when the one set of random numbers is verified to be inappropriate, the random number generator is further configured to change the seed to change the one set of random numbers.

19. The apparatus of claim 11, wherein the object includes Korean character, the basic object includes an initial consonant, a middle vowel, or a final consonant of Korean character, and the basic object primary creator is further configured to, after controlling to determine the first factors of the middle vowel, determine the first factors of the initial consonant or the first factors of the final consonant.

20. The apparatus of claim 19, further comprising an input unit configured to store graphical information corresponding to the basic object,
wherein the graphical information corresponding to the basic object comprises any one of font graphical information, handwriting graphical information, or calligraphy graphical information.

21. The apparatus of claim 19, wherein the first basic object generator is further configured to, by using a system diagram in a form of a decision tree, after determining the first factors of the middle vowel, determine the first factors of the initial consonant or the first factors of the final consonant, the system diagram in the form of the decision tree including information about a combination method considering spatial and morphological relationships of the initial consonant, the middle vowel, and the final consonant, the determining the first factors of the middle vowel and the determining the first factors of an initial consonant or the first factors of a final consonant being performed by branching based on a probability in the system diagram in the form of the decision tree.
